(19) United States
(12) Patent Application Publication
(10) Pub. No.: US 2008/0101748 A1
(43) Pub. Date: May 1, 2008

(54) MEMS DEVICE LEVER

(75) Inventors: Adel B. Jilani, Corvalis, OR (US); Kenneth James Faase, Corvallis, OR (US); Bao Sung B. Yeh, Corvallis, OR (US); Arthur R. Piehl, Corvallis, OR (US); Michael G. Monroe, Philomath, OR (US); James R. Przybyla, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/553,459

(22) Filed: Oct. 26, 2006

(51) Int. Cl. G02B 6/42; G02B 6/26

(52) U.S. Cl. 385/18; 359/290

(57) ABSTRACT

A MEMS device and method include a mechanical plate that is raised or lowered by pivoting a lever coupled to the mechanical plate by a flexible beam.

### BACKGROUND

MEMS devices may include structures, such as reflectors, that are to be raised or lowered. MEMS arrangements for raising and lowering such structures may be complex and may suffer from reduced performance or instability over time as a result of wear and mechanical stress.

### BRIEF DESCRIPTION OF THE DRAWINGS

FIG. 1 is a side elevational view schematically illustrating one example of a MEMS device according to an example embodiment.

FIG. 2 is a bottom perspective view of another embodiment of the MEMS device of FIG. 1 with portions omitted for purposes of illustration according to an example embodiment.

FIG. 3 is a top perspective view of the MEMS device of FIG. 1 with portions omitted for purposes of illustration according to an example embodiment.

FIG. 4 is a graph illustrating one example method of actuating the MEMS device of FIGS. 2 and 3 according to an example embodiment.

FIG. 5 is a fragmentary top perspective view of another embodiment of the MEMS device of FIG. 1 according to an example embodiment.

FIG. 6 is a top plan view of another embodiment of the MEMS device of FIG. 1 according to an example embodiment.

FIG. 7 is a top plan view of another embodiment of the MEMS device of FIG. 1 according to an example embodiment.

### DETAILED DESCRIPTION OF THE EXAMPLE EMBODIMENTS

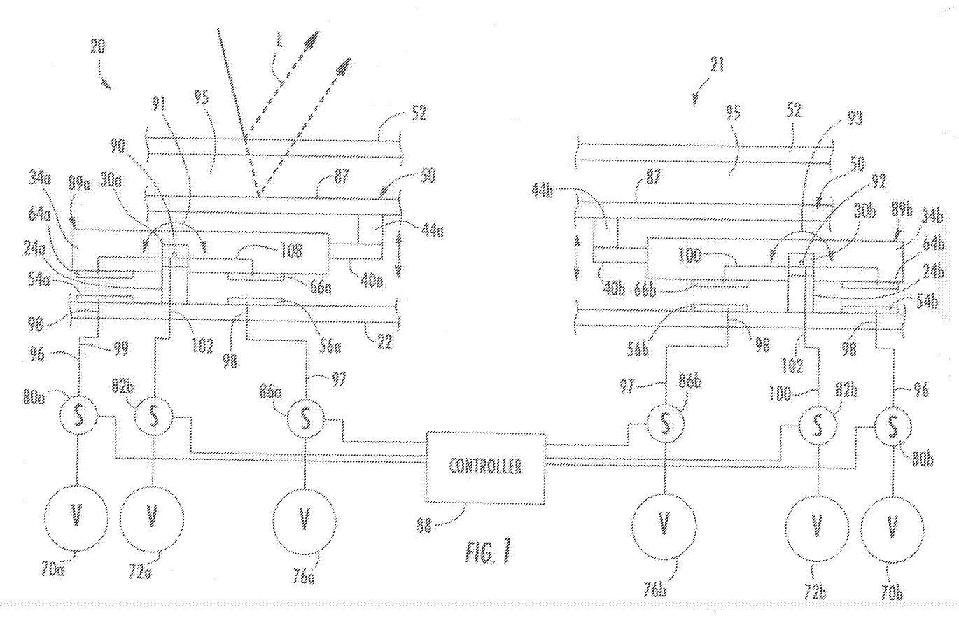

FIG. 1 schematically illustrates one example of a MEMS device 20 according to an example embodiment. MEMS device 20 comprises a micro-machine light modulator configured for use in display applications. Examples of display applications in which device 20 may be employed include, but are not limited to, digital projectors, wearable displays, cameras, cell phones, personal data assistance (PDAs), color wheel replacement for the DLD projectors and the like. In other embodiments, components of MEMS device 20 may be modified, permitting device 20 to the used in other non-display applications where one or more structures are to be raised or lowered.

Device 20 includes multiple pixel cells 21, one of which is shown. Cell 21 generally includes base layer 22, posts 24a, 24b (collectively referred to as posts 24), torsional pivots or hinges 30a, 30b (collectively referred to as hinges 30), levers 34a, 34b (collectively referred to as levers 34), flexible beams 40a, 40b (collectively referred to as beams 40) spacers 44a, 44b (collectively referred to as spacers 44) reflector 50, partial reflector 52, base electrodes 54a, 54b (collectively referred to as electrodes 54), base electrodes 56a, 56b (collectively referred to as electrodes 56), lever electrodes 64a, 64b (collectively referred to as electrodes 64), lever electrodes 66a, 66b (collectively referred to as electrodes 66), voltage sources 70a, 70b, 72a, 72b, 76a, 76b, switching elements 80a, 80b, 82a, 82b, 86a, 86b and controller 88. Certain elements of device 20 may be shared or may extend across multiple consecutive or neighboring cells 21. For example, base layer 22 and partial reflector 52 may continuously extend across multiple neighboring cells 21.

Base layer 22 comprises a layer of dielectric material supporting electrodes 54, electrodes 56 and posts 24. Base layer 22 may overlie one or more additional layers which include electrically conductive traces or lines 99 (schematically shown). In particular embodiments employing active matrix control, layer 22 may also overlie one or layers including switching elements 80, 82 and 86. In one embodiment, base layer 22 may comprise silicon. In other embodiments, base layer 22 may comprise other dielectric materials.

Posts 24 comprise rigid structures extending from base layer 22 and supporting hinges 30 above base layer 22. In one embodiment, posts 24 are formed from one or more electrically conductive materials, wherein electrodes 64a and 66a or electrodes 64b and 66b may be charged to a common voltage. In one embodiment, posts 24 are formed from a conductive material such as TaAl. In other embodiments, other electrically conductive materials may be used to form posts 24.

Hinges 30, levers 34, beams 40 spacers 44 and the two pair of opposing electrodes 54,64 and 56,66 form lever systems 89a and 89b for raising and lowering reflector 50 relative to partial reflector 52. In the example illustrated, cell 21 of device 20 includes a pair of lever systems. Hinges 30 are structures extending between posts 24 and levers 34 that are configured to torsionally twist, facilitating pivoting of levers 34. In the example illustrated, hinge 30a is configured to facilitate pivoting of lever 34a about axis 90 in either direction as indicated by arrows 91. Likewise, hinge 30b is configured to facilitate pivoting of lever 34b about axis 92 in either direction as indicated by arrows 93. In one embodiment, each of hinges 30 is formed from an appropriate material having appropriate dimensions and thicknesses such that hinges 30 may torsionally twist. In the particular example illustrated, hinges 30 are configured to torsionally twist in response to electrostatic forces between either electrodes 54 and 64 or electrodes 56 and 66 ranging between about zero and about 3 uN. Hinges 30 are configured to sufficiently twist such that levers 34 either raise or lower reflector 50 a displacement distance of between about 100 nm and 300, and nominally about 150 nm. In the example illustrated, each of hinges 30 is formed from an electrically conductive material, permitting electrical charge to be transmitted across hinges 30 to electrodes supported by the associated lever 34. According to one embodiment, hinges 30 are provided by a layer formed from TaAl and having a thickness of between about 500 Angstroms and about 3000 Angstroms. In one embodiment, hinges 30 have a width of between about 1 um and about 3 um and a length of between about 5 um and about 10 um. In other embodiments, hinges 30 may be formed from other materials and may have other dimensions.

Levers 34 are substantially stiff or rigid structures coupled to hinges 30 between hinges 30 and beams 40. Levers 34a and 34b pivot about axes 90 and 92, respectively, in response to electrostatic forces selectively established between base electrodes 54, 56 and lever electrodes 64, 66. In one embodiment, each of levers 34 is formed from an electrically conductive material such that levers 34 conduct electrical charge to lever electrodes 64 and 66. In those embodiments in which levers 34 are formed from electrically conductive material, electrodes 64 and 66 may be provided by the one more layers of levers 34 themselves. In one embodiment, levers 34 are formed from a layer of TaAl having a thickness of between about 0.2 um and about 0.4 um, having a width of between about 1 um and about 3 um and a length of between about 5 um and about 10 um. In other embodiments, levers 34 may be formed from other materials and may have other configurations or dimensions.

Beams 40 are structures coupled between levers 34 and spacers 44 that are configured to sufficiently flex during pivoting of levers 34 to assist in maintaining reflector 50 in a substantially level orientation, substantially parallel to partial reflector 52. In particular, beams 40 are configured to flex in response to pivoting of lever 34 which pivoting response to electrostatic forces between electrodes 54 and 64 and between electrodes 56 and 66. According to one embodiment, beams 40 are formed from the same material as that forming hinges 30 and have generally the same thickness as hinges 30. According to one embodiment, beams 40 are formed from TaAl and have a thickness of between about 500 angstroms and 3000 angstroms. According to one embodiment, beams 40 have a width of about 2 um and a length between an associated lever 34 and an associated spacer 44 of about 2 um. In other embodiments, beams 40 may be formed from other materials and may have other configurations.

Spacers 44 comprise one or more as layers or other structures extending between beam 40 and reflector 50. Spacers 44 elevate or support reflector 50 above beams 40 and above levers 34, allowing levers 34 to pivot about axes 90 and 92 with reduced likelihood of contacting reflector 50. Spacers 44 rigidly connect beams 40 to reflector 50. According to one embodiment, spacers 44 are formed from the same material as that forming beams 40 to facilitate fabrication and adhesion. However, spacers 44 have a greater thickness as compared to the thickness of beams 40. In one embodiment, spacers 44 are formed from TaAl and have a thickness of at least about 0.2 um and nominally about 0.3 um. In yet other embodiments, spacers 44 may be formed from other materials and may have other dimensions or configurations.

Reflector 50 is a structure including one or more layers configured to reflect electromagnetic radiation, such as visible light. Reflector 50 is supported by spacers 44 above levers 34 and is substantially rigid. In one embodiment, reflector 50 is formed from multiple layers including a top highly reflective layer formed from material such as AlCu or other highly reflective materials such as Al or Ag. In one particular embodiment, reflector 50 includes at least 3 layers with AlCu on top and bottom. In such an embodiment, the stresses imposed on the two AlCu layers cancel to create a structure with balanced differential stress across its thickness for improved flatness after release, reducing the likelihood of warp. In other embodiments, reflector 50 may be formed from other materials and may have other configurations. In yet other MEMS devices, reflector 50 may comprise other forms of a mechanical plate which may or may not be reflective and which may have other properties.

Partial reflector 52 constitutes one or more layers of semi-transparent, semi-reflective material and one or more layers of electrically conductive material suspended relative to reflective face 87 of reflector 50 to form optical cavity 95. Optical cavity 95 is configured to have a varying thickness such that light L emitted from pixel cell 21 may have wavelengths ranging across the entire portion of the visible spectrum. Partial reflector 52 cooperates with reflective face 93 to constructively interfere with light so as to allow the reflection of a particular range of the wavelengths of the light. Because reflector 50 is raised or lowered using electrostatic forces selectively created between electrodes 54 and 64 or between electrodes 56 and 66 to adjust the thickness of optical cavity 95, partial reflector 52 may be formed from one or more electrically conductive materials or dielectric materials and may be disconnected from a voltage source. In the particular embodiment illustrated, partial reflector 52 is formed from TaAl. In other embodiments, partial reflector 52 may be formed from other materials such as a wide range of metals, alloys, intermetallics and dielectrics. In other MEMS devices, partial reflector 52 may be omitted or may be replaced with other structures having other properties.

Electrodes 54 and electrodes 56 are electrically conductive areas supported by base layer 22 substantially opposite to electrodes 64 and 66, respectively. Electrodes 54 and 56 are configured to be charged independently of one another to distinct voltages using electrically conductive paths 96 and 97, respectively. As shown by FIG. 1, electrically conductive paths 96 and 97 extend from switches 80 and 86 to electrodes 54 and 56 through electrically conductive vias 98 (schematically shown) formed within base layer 22. Electrodes 54 and 56 extend on substantially opposite sides of pivot axes 90 and cooperate with electrodes 64 and 66, respectively, to create electrostatic forces so a to selectively pivot levers 34 about axes 90 and 92 to selectively raise or lower reflector 50. In one embodiment, electrodes 54 and 56 are formed from a patterned layer of electrically conductive material deposited upon base layer 22. In one embodiment, electrodes 54 and 56 may be formed from an electrically conductive material such as TaAl. In one embodiment, electrodes 54 have an area of at least about 50 um² and are spaced from axes 90 between about 5 um and about 10 um. Electrodes 56 have an area of at least about 50 um² and are spaced from axes 90 between about 5 um and about 10 um. In other embodiments, electrodes 54 and 56 may be formed from other materials, may be formed in other manners and may have other dimensions.

Electrodes 64 and 66 are electrically conductive areas supported by levers 34 substantially opposite to electrodes 64 and 66, respectively. In the particular example illustrated, electrodes 64 and 66 are configured to be charged to the same voltage via a single electrically conductive path 100 (schematically illustrated). In the example illustrated, the electrically conductive path 100 extends from switches 82, extends through base layer 22 by means of an electrically conductive via 102, extends through posts 24 and hinges 30 which are formed from an electrically conductive material and further extends through lever 34 which is also formed from an electrically conductive material. In one embodiment, electrodes 64 and 66 do not comprise distinct structures coupled to lever 34 but are portions of lever 34 itself which extend generally opposite to electrodes 54 and 56. In other embodiments, electrodes 64 and 66 may be distinct structures coupled to levers 34 and receiving charge through the material forming lever 34 itself or through an electrically conductive trace or line carried by lever 34. In other embodiments, posts 24 and hinges 30 may also alternatively be formed from one or more dielectric materials, wherein path 100 is provided by one or more electrically conductive traces or lines extending through or supported by posts 24 and hinges 30. Electrodes 64 and 66 extend on substantially opposite sides of pivot axes 90 and cooperate with electrodes 54 and 56, respectively, to create electrostatic forces so as to selectively pivot levers 34 about axes 90 to selectively raise or lower reflector 50.

Switches 80, 82, 86 are devices or elements configure to facilitate selective charging of electrodes 54, 56, 64 and 66 to different voltages to selectively vary electrostatic forces between such electrodes to control pivoting of levers 34 and the raising or lowering of reflector 50. In one embodiment, switches 80, 82, 86 include one or more thin film switching elements. According to one example embodiment, switches may include thin film transistors, diodes or metal-insulator-metal devices. According to one embodiment, switches 80, 82, 86 are part of an active-matrix, wherein switches 80, 82, 86 are located below and opposite to reflector 50 or otherwise proximate to each cell 21. In other embodiments, switches 80, 82, 86 may be part of a passive control matrix, wherein switches 80, 82, 86 are located distant from the pixel cells 21 which are selectively controlled using such switches. Switches 80, 82, 86 selectively connect electrodes 54, electrodes 66 and electrodes 56 to voltage sources 70, 72 and 76, respectively, in response to control signals from controller 88.

Although voltage sources 72a and 72b are schematically illustrated as being distinct sources, in other embodiments, voltage sources 72a and 72b may be a single voltage source. Although pixel cell 21 is illustrated as having distinct switches 80a and 80b for electrodes 54a and 54b, enabling different voltages to be applied to electrodes 54a and 54b, in other embodiments, electrodes 54 may share a common switch, wherein electrodes 54 are charged to a common voltage. Likewise, although pixel cell 21 is illustrated as having distinct switches 86a and 86b for electrodes 66a and 66b, enabling different voltages to be applied to electrodes 66, in other embodiments, electrodes 66 may share a common switch, wherein electrodes 66 are charged to a common voltage.

Controller 88 comprises one or more processing units configured to generate control signals and to transmit such control signals to switches 80, 82 and 86 so as to control the thickness of optical cavity 95 of each pixel cells 21 by controlling the positioning of reflector 50 of each pixel cell 21. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 88 is not limited to any specific combination of hardware circuitry and software, nor to any particular source for the instructions executed by the processing unit.

In operation, controller 88, following instructions contained in a computer readable medium, determines appropriate voltages to be applied to one or more of electrodes 54, 56 and 66 to cause lever systems 89 to move reflector 50 such that optical cavity 95 has a desired thickness and incident light L that is reflected has an appropriate wavelength or color for the individual pixel cell 21 which corresponds to a particular pixel of an image to be displayed. Based on this determination, controller 88 generates control signals which direct switches 80, 82 and 86 to selectively supply voltages from voltage sources 70, 72 and 76 to electrodes 54, 66 and 56, respectively. The voltages applied to electrodes 54, 56 and 66 create electrostatic forces between such electrodes. The electrostatic forces cause levers 34 to pivot about axes 90 and 92 to raise or lower reflector 50. During such pivoting, beams 40 flex to substantially maintain reflector 50 in a substantially horizontal or level orientation in which reflector 50 extends substantially parallel to partial reflector 52.

Because the positioning of reflector 50 relative to partial reflector 52 is achieved by use of levers 34, rather than electrostatic forces between partial reflector 52 and reflector 50, reflector 50 may be moved closer to partial reflector 52 with a reduced likelihood of contact with partial reflector 52, without stiction bumps and without associated stiction issues with such bumps. In addition, in those embodiments in which stiction bumps are omitted, wear of those portions of reflector 50 in contact with such bumps is also reduced or eliminated. Because control of the positioning of reflector 50 is performed entirely from below reflector 50 and because the positioning of reflector 50 may be adjusted without applying voltage to reflector 50 or partial reflector 52, device 20 may be less complex.

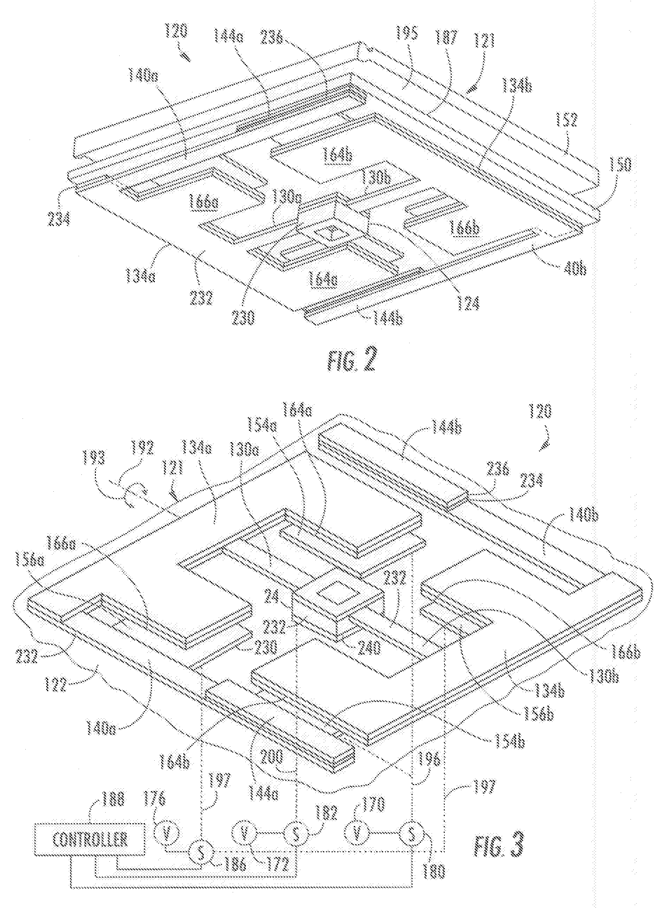

FIGS. 2 and 3 illustrate MEMS device 120, another embodiment of MEMS device 20 shown in FIG. 1. In particular, FIGS. 2 and 3 illustrate an embodiment of MEMS device 120 in which device 120 is a micro-machine light modulator configured for use in display applications. In the example illustrated, device 120 is a Fabry-Perot light modulator. FIGS. 2 and 3 illustrate a single pixel cell 121 of the light modulator.

As shown by FIG. 2, device 120 includes base layer 122, posts 124a, 124b (collectively referred to as posts 124), torsional pivots or hinges 130a, 130b (collectively referred to as hinges 130), levers 134a, 134b (collectively referred to as levers 134), flexible beams 140a, 140b (collectively referred to as beams 140) spacers 144a, 144b (collectively referred to as spacers 144) reflector 150, partial reflector 152, base electrodes 154a, 154b, (collectively referred to as electrodes 154), base electrodes 156a, 156b (collectively referred to as electrodes 156), lever electrodes 164a,164b (collectively referred to as electrodes 164), lever electrodes 166a, 166b (collectively referred to as electrodes 166), voltage sources 170, 172, 176, switching elements 180, 182, 186 and controller 188. Certain elements may be shared or may extend across multiple consecutive cells 121. For example, base layer 122 and partial reflector 152 may continuously extend across multiple consecutive cells 121.

Base layer 122 comprises a layer of dielectric material supporting electrodes 154, electrodes 156 and post 124. Base layer 122 may overlie one or more additional layers which include electrically conductive traces or lines 199 (schematically shown). In particular embodiments employing active matrix control, layer 122 may also overlie one or layers including switching elements 180, 182, and 86. In one embodiment, base layer 122 may comprise silicon. In other embodiments, base layer 122 may comprise other dielectric materials.

Post 124 comprise rigid structures extending from base layer 122 and supporting hinges 130 above base layer 122. In the example illustrated, post 124 is substantially centrally located below reflector 150. In one embodiment, post 124 is formed from one or more electrically conductive materials, wherein electrodes 164 and 166 may be charged to a common voltage. In one embodiment, post 124 is formed from a conductive material such as TaAl. In other embodiments, other electrically conductive materials may be used to form post 124.

Hinges 30 are structures extending between post 124 and levers 134 that are configured to torsionally twist, facilitating pivoting of levers 134. In the example illustrated, hinge 130a is configured to facilitate pivoting of lever 134a about axis 192 in either direction as indicated by arrows 193. Likewise, hinge 130b is configured to facilitate pivoting of lever 134b about axis 192 in either direction as indicated by arrows 193. In one embodiment, each of hinges 130 is formed from an appropriate material having appropriate dimensions and thicknesses such that hinges 130 may torsionally twist. In the particular example illustrated, hinges 130 configured to torsionally twist in response to electrostatic forces between either electrodes 154 and 164 or electrodes 156 and 166 ranging between about 0.5 uN and about 3 uN. Hinges 130 are configured to sufficiently twist such that levers 134 either raise or lower reflector 150 a displacement distance of between about 50 nm and 200 nm, and nominally about 150 nm. In the example illustrated, each of hinges 130 is formed from an electrically conductive material, permitting electrical charge to be transmitted across hinges 130 to electrodes supported by the associated lever 134. According to one embodiment, hinges 130 are provided by a layer formed from TaAl and having a thickness of between about 500 Angstroms and about 3000 Angstroms. In one embodiment, hinges 130 have a width of between about 0.5 um and about 1 um and a length of between about 2 um and about 4 um. In other embodiments, hinges 130 may be for from other materials and may have other dimensions.

Levers 134 are substantially stiff or rigid structures coupled to hinges 130 between hinges 130 and beams 140. Levers 134a and 134b pivot about axis 192, an response to electrostatic forces selectively established between base electrodes 154, 156 and lever electrodes 164, 166. In one embodiment, each of levers 134 is formed from an electrically conductive material such that levers 134 conduct electrical charge to lever electrodes 164 and 166. In those embodiments in which levers 34 are formed from electrically conductive material, electrodes 64 and 66 may be provided by the one more layers of levers 134 themselves. In one embodiment, levers 134 are formed from a layer of TaAl having a thickness of between about 0.2 um and about 0.4 um, having a width of between about 1.5 um and about 3 um and a length of between about 4 um and about 6 um. In other embodiments, levers 134 may be formed from other materials and may have other configurations or dimensions.

Beams 140 are structures coupled between levers 134 and spacers 144 that are configured to sufficiently flex during pivoting of levers 134 to assist in maintaining reflector 150 in a substantially level orientation, substantially parallel to partial reflector 152 (shown in FIG. 2). In particular, beams 140 are configured to flex in response to pivoting of lever 134 which pivoting response to electrostatic forces between electrodes 154 and 164 and between electrodes 156 and 166. According to one embodiment, beams 140 are formed from the same material as that forming hinges 130 and have generally the same thickness as hinges 130. According to one embodiment, beams 140 are formed from TaAl and have a thickness of between about 500 Angstroms and 3000 Angstroms. According to one embodiment, beams 40 have a width of about 1 um and a length between an associated lever 134 and an associated spacer 144 of about 5 um. In other embodiments, beams 140 may be formed from other materials and may have other configurations.

Spacers 144 comprise one or more layers or other structures extending between beams 140 and reflector 150. Spacers 144 elevate or support reflector 150 above beams 140 and above levers 134, allowing levers 134 to pivot about axis 192 with reduced likelihood of contacting reflector 150. Spacers 144 for rigidly connect beams 140 to reflector 150. According to one embodiment, spacers 144 are formed from the same material as that forming beams 140 to facilitate fabrication and adhesion. However, spacers 144 have a greater thickness as compared to the thickness of beams 140. In one embodiment, spacers 144 are formed from TaAl and have a thickness of at least about 0.2 um and nominally about 0.3 um. In yet other embodiments, spacers 44 may be formed from other materials and may have other dimensions or configurations.

Reflector 150 is a structure including one or more layers configured to reflect electromagnetic radiation, such as visible light. Reflector 150 is supported by spacers 144 above levers 134 and is substantially rigid. In one embodiment, reflector 150 is formed from multiple layers including a top highly reflective layer formed from material such as AlCu or other highly reflective materials such as Al or Ag. In one particular embodiment, reflector 150 includes at least 3 layers with AlCu on top and bottom. In such an embodiment, the stresses imposed on the two AlCu layers substantially cancel to create a structure with balanced differential stress across its thickness for improved flatness after release, reducing the likelihood of warp. In other embodiments, reflector 150 may be formed from other materials and may have other configurations.

Partial reflector 152 constitutes one or more layers of semi-transparent, semi-reflective material and one or more layers of electrically conductive material suspended relative to reflective face 187 of reflector 150 to form optical cavity 195. Optical cavity 195 is configured to have a varying thickness such that light emitted from pixel cell 121 may have wavelengths ranging from the entire portion of the visible spectrum. Partial reflector 152 cooperates with reflective face 187 to constructively interfere with light so as to allow the reflection of a particular range of the wavelengths of the light. Because reflector 150 is raised or lowered using electrostatic forces selectively created between electrodes 154 and 164 or between electrodes 156 and 166 to adjust the thickness of optical cavity 195, partial reflector 152 may be formed from one or more electrically conductive materials or dielectric materials and may be disconnected from a voltage source. In the particular embodiment illustrated, partial reflector 152 is formed from TaAl. In other embodiments, partial reflector 152 may be formed from other materials such as a wide range of metals, alloys, intermetallics and dielectrics.

Electrodes 154 and electrodes 156 are electrically conductive areas supported by base layer 122 substantially opposite to electrodes 164 and 166, respectively. Electrodes 154 and 156 are configured to be charged independently of one another to distinct voltages using electrically conductive paths 196 and 197, respectively. Electrodes 154 and 156 extend on substantially opposite sides of pivot axis 192 and cooperate with electrodes 164 and 66, respectively, to create electrostatic forces so as to selectively pivot levers 34 about axes 192 to selectively raise or lower reflector 150. In one embodiment, electrodes 154 and 56 are formed from a patterned layer of electrically conductive material deposited upon base layer 122. In one embodiment, electrodes 154 and 156 may be formed from an electrically conductive material such as TaAl. In one embodiment, electrodes 154 have an area of at least about 25 um² and are spaced from axes 192 between about 5 um and about 10 um. Electrodes 156 have an area of at least about 25 um² and are spaced from axis 192 between about 5 um and about 10 um. In other embodiments, electrodes 154 and 156 may be formed from other materials, may be formed another manners and may have other dimensions.

Electrodes 164 and 166 are electrically conductive areas supported by levers 134 substantially opposite to electrodes 164 and 166, respectively. In the particular example illustrated, electrodes 164 and 166 are configured to be charged to the same voltage via a single electrically conductive path as schematically illustrated by lines 200. In the example illustrated, the electrically conductive path 200 extends from switch 182, extends through base layer 122 by means of an electrically conductive via (not shown), extends through post 124 and hinges 130 which are formed from an electrically conductive material and further extends through lever 134 which is also formed from an electric conductive material. In the embodiment illustrated, electrodes 164 and 166 do not comprise distinct structures coupled to lever 134 but are portions of lever 134 itself which extend generally opposite to electrodes 154 and 56. In other embodiments, electrodes 164 and 166 may be distinct structures coupled to levers 134 and receiving charge through the material forming lever 134 itself or through an electrically conductive trace or line carried by lever 134. In other embodiments, post 124 and hinges 130 may also alternatively be formed from one or more dielectric materials, wherein path 200 is provided by one or more electrically conductive traces or lines extending through or supported by posts 124 and hinges 130. Electrodes 64 and 166 extend on substantially opposite sides of pivot axis 192 and cooperate with electrodes 154 and 56, respectively, to create electrostatic forces so as to selectively pivot levers 34 about axis 192 to selectively raise or lower reflector 150.

Switches 180, 182, 186 are devices or elements configure to facilitate selective charging of electrodes 154, 156, 164 and 166 to different voltages to selectively vary electrostatic forces between such electrodes to control pivoting of levers 34 and the raising or lowering of reflector 150. In one embodiment, switches 180, 182, 186 include one or more thin film switching elements. According to one example embodiment, switches may include thin film transistors, diodes or metal-insulator-metal devices. According to one embodiment, switches 180, 182, 186 are part of an active-matrix, wherein switches 180, 182, 186 are located below or opposite to reflector 150 or otherwise proximate to each cell 121. In other embodiments, switches 180, 182, 186 may be part of a passive control matrix, wherein switches 180, 182, 186 are located distant from the pixel cells 21 which are selectively controlled using such switches. Switches 180, 182, 186 selectively connect electrodes 154, electrodes 166 and electrodes 156, to voltage sources 170, 172 and 176, respectively, in response to control signals from controller 88.

Controller 188 comprises one or more processing units configure to generate control signals and to transmit such control signals to switches 180, 182 and 186 so as to control the thickness of optical cavity 195 of each pixel cells 121 by controlling the positioning of reflector 150 of each pixel cell 121.

FIGS. 2 and 3 further illustrate one example construction of device 120 which may facilitate fabrication. As shown by FIGS. 2 and 3, cell 121 includes layers 230, 232, 234 and 236 which form the electrodes 154 and 156, post 124, hinges 130, levers 134, beams 140 and spacers 144 of device 120. Layer 230 comprises a layer of electrically conductive material, such as TaAl, selectively patterned upon base layer 122 using known photolithography techniques to form the electrodes 154 and 56 as well as a base portion 240 of post 124. Layer 230 is patterned such that electrodes 154, 156 and base portion 240 are in electrical contact with electrically conductive vias (not shown) formed in base layer 122. Thereafter, one or more layers of sacrificial material (not shown), such as sacrificial Si, are deposited and patterned using known photolithography and etching techniques, to define spacing between layer 232 and layer 230. The sacrificial layer is provided with a centrally located cavity extending to base portion 240 of layer 230.

Layer 232 comprises a layer of electrically conductive material, such as TaAl, which is deposited upon the sacrificial layer (not shown) overlying base layer 122 and electrodes 54 and 56. Layer 232 fills the central cavity of the sacrificial layer such that post 124 elevates a remainder of layer 232 above layer 230 upon removal of the sacrificial layer. As shown by FIGS. 2 and 3, layer 232 provides both hinges 130 and beams 140. Layer 232 further provides a foundation for levers 134 and spacers 144. In one embodiment, layer 232 is formed from TaAl and has a thickness of between about 500 Angstroms and 3000 Angstroms.

After the deposition of layer 232, one or more additional layers of sacrificial material (not shown), such as sacrificial Si, are patterned over layer 232 to define areas or voids where layer 234 is to be deposited. Prior to the deposition of such sacrificial material, portions of layer 232 forming hinges 130 and beams 140 may additionally have a hard mask patterned thereon for protecting such portions from subsequent etches.

Layer 234 is selectively patterned and deposited in such voids on top of and in contact with exposed portions of layer 232. In the embodiment illustrated, layer 234 is formed from an electrically conductive material, such as TaAl, and has a relatively larger thickness as compared to layer 232. Layer 234 defines the shape of levers 134 by adding stiffness to selected portions of layer 232. Layer 234 further builds up a height of spacers 144. In one embodiment, layer 234 has a thickness of about 0.2 um. In other embodiments, layer 234 may be formed from other materials and may have other thicknesses.

Once layer 234 has been deposited, a hard mask layer (not shown) is selectively deposited upon remaining portions of layer 234 except for those remaining portions of layer 234 which are part of spacers 144. One or more layers of sacrificial material (not shown), such as sacrificial Si, and potentially intermediate sacrificial layers of SiN between layers of sacrificial Si to promote adhesion, are subsequently selectively patterned and deposited over the hard mask layer and over previously deposited layers of sacrificial material while exposing those portions of layer 234 which form part of spacers 144.

Layer 236 is selectively patterned upon the layer of sacrificial material and upon exposed portions of layer 234 to form and add additional height to spacers 144. In one embodiment, layer 236 is an electrically conductive material, such as TaAl, and has a thickness of about 0.2 um. In other embodiments, layer 236 may be formed from other materials and may have other thicknesses.

Upon the formation of spacers 144, one or more additional layers of sacrificial material are selectively patterned and deposited such that upper surfaces of spacers 144 remain exposed for subsequent deposition of those layers of materials forming reflector 150 so as to connect spacers 144 to reflector 150. The sacrificial layers and hard mask layers are subsequently removed, achieving device 120. In other embodiments, device 120 may be formed from a variety of other known or future developed MEMS or semiconductor fabrication processes.

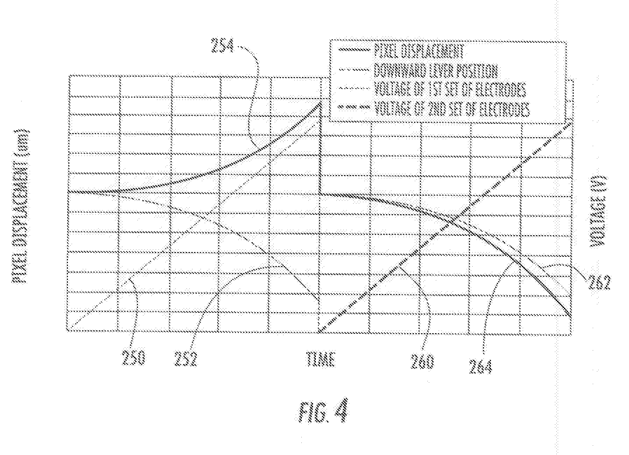

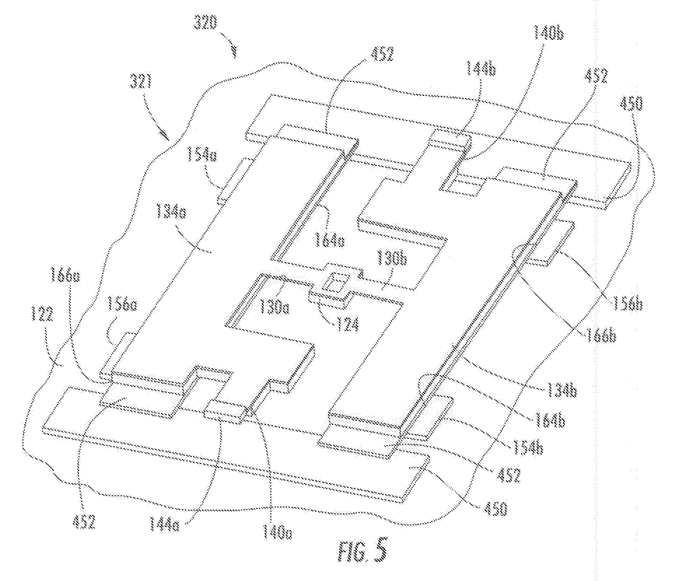

FIG. 4 illustrates operation of pixel cell 121. In particular, FIG. 4 illustrates displacement of reflector 150 in response to various voltages applied to electrodes 154, 156 and 166 by switches 180, 182 and 186, voltage sources 170, 172 and 176 and controller 188 (all of which are shown in FIG. 3). In one scenario, as indicated by line 250, controller 188 generates control signals causing switch 80 to steadily increase the voltage applied to electrodes 154 (shown in FIG. 3). As this occurs, no voltage is applied to electrodes 156 or 166. As indicated by line 252, this increase in voltage increases electrostatic attraction between electrodes 154 and 164 (shown in FIG. 3), resulting in lever 134a pivoting about axis 192 in a clockwise direction as seen in FIG. 3 and lever 134b pivoting about axis 192 in a counter-clockwise direction as seen in FIG. 3. As indicated by line 254, pivoting of levers 134 results in reflector 150 being upwardly displaced towards partial reflector 152 (shown in FIG. 2) to reduce a thickness of optical cavity 195. According to one embodiment, the voltage applied is increased from approximately zero volts to approximately 25 V over a time period of approximately 20 μs which results in electrodes 64 being upwardly displaced towards electrodes 54 by about 0.1 μm and which results in reflector 150 being upwardly displaced by about 0.09 μm.

FIG. 4 further illustrates downward displacement of reflector 150. In one scenario, as indicated by line 260, controller 188 generates control signals causing switch 186 to steadily increase the voltage applied to electrodes 156 (shown in FIG. 3). As this occurs, no voltage is applied to electrodes 156 or 166. As indicated by line 262, this increase in voltage increases electrostatic attraction between electrodes 156 and 166 (shown in FIG. 3), resulting in lever 134a pivoting about axis 192 in a counter-clockwise direction as seen in FIG. 3 and lever 134b pivoting about axis 192 in a clockwise direction as seen in FIG. 3. As indicated by line 264, pivoting of levers 134 results in reflector 150 being cowardly displaced away from partial reflector 152 (shown in FIG. 2) to increase a thickness of optical cavity 195. According to one embodiment, the voltage applied is increased their approximate zero to approximate 25 V over a time period of approximately 20 μs which results in electrodes 66 being downwardly displace toward electrodes 56 by about 0.1 μm and which results in reflector 150 being downwardly displaced from its original position by about 0.12 μm. In other embodiments, the voltages, times and displaced and values may be altered and different operation characteristics may be achieved. For example, in other electrostatic attraction or repulsion forces to pivot levers 34.

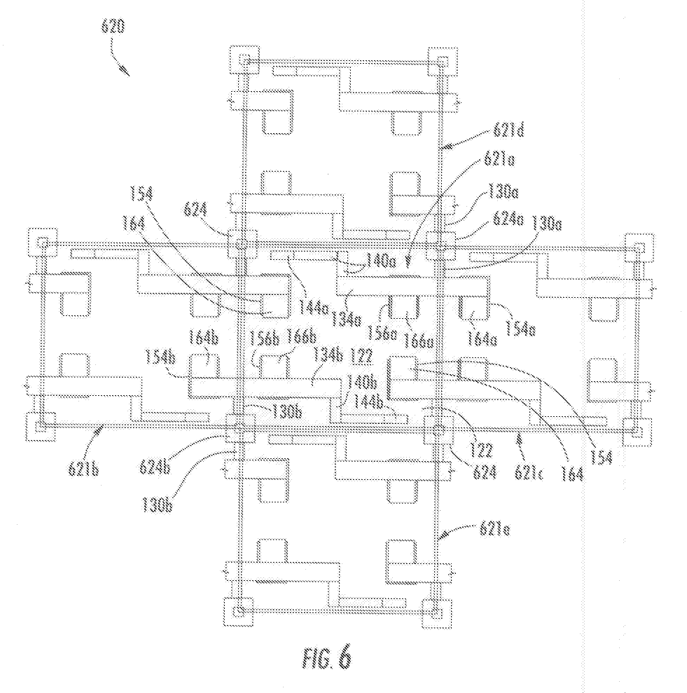

FIG. 5 illustrates MEMS device 320, another embodiment of device 20 shown in FIG. 1. Device 320 is similar to device 220 (shown in FIGS. 2 and 3) except that device 320 additionally includes landing pads 450 and springs 452. Those remaining structures or components of device 320 which are similar to corresponding structures of device 220 are numbered similarly. For ease of illustration, FIG. 5 omits the illustration of reflector 150, partial reflector 152, voltage sources 170, 172, 176, switches 180, 182 and 186 and controller 188 of device 320 which are shown and described with respect to device 120.

Landing pads 450 are structures projecting above base layer 122 and configured to serve as structures against which springs 452 contact prior to contact between electrodes 154 and 164 or between electrodes 156 and 166 during pivoting of levers 134. In the particular example illustrated, landing pads 450 extend along opposite parameters of pixel cell 321 such that landing pads 450 may be shared with adjacent or neighboring pixel cells 321. In other embodiments, landing pads 450 may be located at other locations.

Springs 452 are resilient structures extending from levers 134 which are configured to contact opposite portions of landing pads 450 prior to contact between electrodes 154 and 164 or between electrodes 156 and 166 during pivoting of levers 134. Springs 452 minimize contact stresses. As the same time, springs 452 are sufficiently flexible so as to store strain energy when deformed. The stored strain energy may be used to overcome stiction forces when levers 134 are released. According to one embodiment, springs 452 are integrally formed as part of a single unitary body out of the same layer of material also forming hinges 130 and beams 140. In one embodiment, springs 452 are formed from an electrically conductive material, such as TaAl, and have a thickness of between about 500 Angstroms and 3000 Angstroms. In other embodiments, springs 452 may be formed from other materials and may have other thicknesses. In yet other embodiments, springs 452 may be omitted.

FIG. 6 illustrates MEMS device 620, another embodiment of MEMS device 20, shown in FIG. 1. In particular, FIG. 6 is a top plan view illustrating five neighboring pixel cells 621a, 621b, 621c, 621d and 621e of device 620 (collectively referred to as cells 621) with portions omitted for purposes of illustration. In particular, device 620 is illustrated without reflector 150 and partial reflector 152 (shown in FIG. 2). In the example illustrated, device 620 is a Fabry-Perot light modulator for use in display applications.

Device 620 is similar to device 120 except that device 620 includes a pair of corner posts 624 for each cell 621 in lieu of a single center post 124. Those remaining elements of each cell 621 of device 620 which are similar to corresponding elements of device 120 are numbered similarly. As shown by FIG. 6, cell 621a includes posts 624a and 624b (collectively referred to as posts 624) which extend upward from base layer 122 at opposite corners of cell 621a. Posts 624 support hinges 130a and 130b for pixel cell 621a. At the same time, posts 624 also support hinges 130a for pixel cell 621d and pixel cell 621e. Because posts 624 are located at corners of neighboring pixel cells 621, the distance between hinges 130 (the axis about which levers 134 pivot) and the point at which levers 134 are coupled to reflector 150 (at spacer 144) is larger. As a result, reflector 150 may be raised and lowered to a greater degree closer to or farther away from partial reflector 152 while experiencing enhanced leveling.

As the further shown by FIG. 6, levers 134 are further elongated so as to extend over a neighboring pixel cell, wherein one of the electrodes for the lever is also located within a neighboring pixel cell. For example, levers 134 of pixel cell 621a extend over pixel cells 621b and 621c. Electrodes 154 of pixel cell 621a are also located within an area of pixel cell 621b and 621c. Likewise, portions of levers 134 and electrodes 154 four pixel cells 621b and 621c are located within pixel cell 621a. As a result, the area of each pixel cell 621 opposite reflector 150 (shown in FIG. 2) is more greatly utilized to increase the effective length of levers 134 to increase leveling effect.

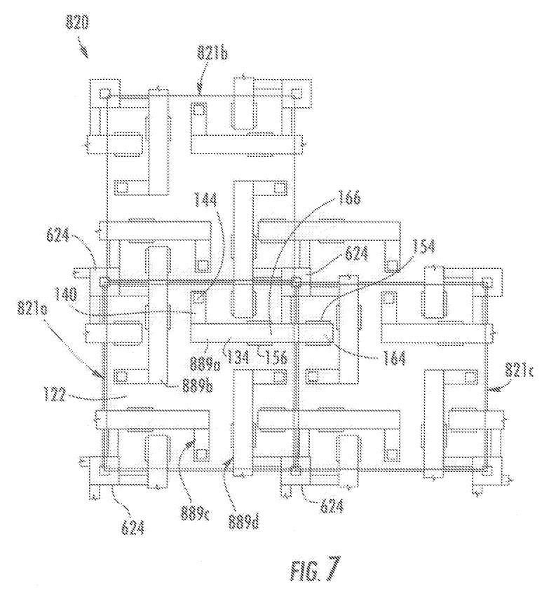

FIG. 7 illustrates MEMS device 820, another embodiment of device 20 shown in FIG. 1. In particular, FIG. 7 is a top plan view illustrating three neighboring pixel cells 821a, 821b and 821c of device 820 (collectively referred to as cells 821) with portions omitted for purposes of illustration. In particular, device 820 is illustrated with reflector 150 and partial reflector 152 (shown in FIG. 2) omitted. In the example illustrated, device 820 is a Fabry-Perot light modulator for use in display applications.

Device 820 is similar to device 620 (shown in FIG. 6) except that each pixel cell 821 utilizes four lever systems instead of just two lever systems. In particular, each corner post 624 supports four lever systems 889a, 889b, 889c and 889d (collectively referred to as lever systems 889) instead of two lever systems. Each lever system 889 includes hinge 130, lever 134, beam 140, spacer 144 and two pairs of opposing electrodes 154, 164 and 156, 166. Hinges 130 extend from corner posts 624 in a pinwheel arrangement about corner post 624. As with cells 621 of device 620, cells 821 of device 820 have levers 134 which cross over and into neighboring pixel cells 821. Likewise, pixel cells 821 have electrodes 154 and 164 which extend into areas of neighboring pixel cells 821. As a result, a greater area of each pixel cell 821 is utilized to increase the distance between hinges 130 (the axis about which levers 134 pivot) and the point at which levers 134 are coupled to reflector 150 (at spacer 144). As a result, reflector 150 (shown in FIG. 2) may be raised and lowered to a greater degree closer to or farther away from partial reflector 152 while experiencing enhanced leveling. Because each pixel cell 821 includes four lever systems 889, providing four spacers 144 and four relatively stiff levers 134 to support reflector 150, each pixel cell 821 experiences reduced strain upon hinges 130 and enhanced balance or leveling of reflector 150.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A MEMS device comprising:
a mechanical plate;
a first support;
a first substantially rigid lever;
a first torsional hinge coupled between the first support and the first lever;
a first set of electrodes disposed under the first lever; and
a first flexible beam coupled to the first lever and the mechanical plate.

2. The MEMS device of claim 1 further comprising:
a second support;
a second substantially rigid lever;
a second torsional hinge coupled between the second support and the second lever;
a second set of electrodes disposed under the second lever; and
a second flexible beam coupled to the second lever.

3. The MEMS device of claim 2 further comprising:
a third support;
a third substantially rigid lever;
a third torsional hinge coupled to the third support;
a third set of electrodes disposed under the third lever; and
a third flexible beam coupled between the reflector and the third lever.

4. The MEMS device of claim 2, wherein the first support and the second support are located at corners of the mechanical plate.

5. The MEMS device of claim 1 further comprising:
a resilient structure coupled to the first lever; and
a landing pad opposite the resilient structure.

6. The MEMS device of claim 5, wherein the MEMS device includes a first pixel cell including the first support, the first lever, the first hinge, the first set of electrodes, and the first plate, wherein the MEMS device further comprises a second pixel cell substantially identical to the first pixel cell and wherein the first pixel cell and the second pixel cell share the landing pad.

7. The MEMS device of claim 1 further comprising:
a second substantially rigid lever;
a second torsional hinge coupled to the second lever;
a second set of electrodes disposed under the second lever; and
a second flexible beam couple between the plate and the second lever.

8. The MEMS device of claim 7, wherein the first hinge and the second hinge extend from opposite sides of the first support.

9. The MEMS device of claim 1, wherein the first support is centrally located opposite the plate.

10. The MEMS device of claim 1, wherein the first lever and the second electrode extend opposite a second plate.

11. The MEMS device of claim 1, wherein the plate comprises a reflector.

12. The MEMS device of claim 11 further comprising a partial reflector opposite the reflector.

13. The MEMS device of claim 1 further comprising a control system configured to apply different voltages to different electrodes of the first set of electrodes.

14. The MEMS device of claim 1 further comprising a tab coupled between and spacing the plate and the first beam.

15. A MEMS device comprising:
a reflector;
substantially rigid levers coupled to the reflector; and
means for selectively pivoting the levers to selectively uniformly raise and lower the reflector.

16. A method comprising:
pivoting a first lever coupled to a reflector by a first flexible beam to raise or lower the reflector.

17. The method of claim 15 further comprising pivoting a second lever coupled to the reflector by a second flexible beam to raise or lower the reflector.

18. The method of claim 15, wherein the reflector is substantially uniformly raised or uniformly lowered.

19. The method of claim 15 further comprising resiliently flexing a resilient structure coupled to the first lever.

20. The method of claim 16 further comprising:
applying a voltage to the first electrode opposite the lever to pivot the lever in a first direction; and
applying a voltage to a second electrode opposite the lever to pivot the lever in a second direction.
